(19) United States
(12) Patent Application Publication
(10) Pub. No.: US 2016/0053380 A1
(43) Pub. Date: Feb. 25, 2016

(54) HIGH TEMPERATURE AND HIGH PRESSURE PORTABLE GAS HEATER

(71) Applicant: UNITED TECHNOLOGIES CORPORATION, Hartford, CT (US)

(72) Inventors: Michael A. Klecka, Vernon, CT (US); Aaron T. Nardi, East Granby, CT (US); Justin R. Hawkes, Marlborough, CT (US); Matthew B. Kennedy, Vernon, CT (US)

(21) Appl. No.: 14/783,223

(22) PCT Filed: Feb. 14, 2014
(86) PCT No.: PCT/US2014/016415

§ 371 Date: Oct. 8, 2015

Related U.S. Application Data
(60) Provisional application No. 61/819,026, filed on May 3, 2013.

(51) Int. Cl. C23C 24/08; F24H 9/00; F24H 3/04; B05B 7/14; B05B 7/16

(52) U.S. Cl. CPC C23C 24/08; B05B 7/1486; B05B 7/1693; F24H 3/0405; F24H 9/0063

(57) ABSTRACT

A portable gas heater includes a housing, a pressure vessel arranged in the housing, a layer of thermal insulation disposed on an interior wall of the pressure vessel, a heating element arranged within the layer of thermal insulation, and a gas diffuser arranged upstream from the heating element. A cold spray system including the portable gas heater and a method of heating gas are also disclosed.

### BACKGROUND

This disclosure relates to a high temperature, high pressure portable gas heater for cold spray material deposition processes.

Cold spray (also known as “cold gas dynamic spray”) material deposition is an additive manufacturing technique in which powdered materials are accelerated in a high velocity gas stream and deposited on a substrate material upon impact. The plastic deformation upon particle impact results in a deposition/consolidation process which has been utilized for a variety of ductile materials. Difficult-to-consolidate materials frequently require higher gas temperatures during spraying in order to increase gas velocity and provide higher impact velocities. Additionally, increased temperature warms the powder particles such that the particles deform more readily during impact, resulting in improved deposit quality.

A device known as a gas heater is utilized to heat and accelerate the gas stream. Current portable cold spray systems are predominantly designed for low temperature and low pressure operation. This limits the available materials which can be deposited. Furthermore, deposits made with low pressure/temperature systems are typically of poor quality, resulting in low strength deposits which are conventionally used only for cosmetic (non-load-bearing) repairs. Additionally, larger and less portable equipment is generally necessary for high temperature and high temperature application and is thus usually stationary.

### SUMMARY

A gas heater for a cold spray deposition system according to an exemplary embodiment of this disclosure, among other possible things includes a housing defining an inlet and an outlet for a gas stream, a pressure vessel defining a gas path through the housing, a heating element supported within the pressure vessel and within the gas path for heating the gas stream, a layer of thermal insulation disposed between the heating element and an interior wall of the pressure vessel, and a diffuser arranged within the gas path between the inlet and the heating element for spreading the gas stream prior to entering the heating element.

In a further embodiment of any of the foregoing gas heaters, the layer of thermal insulation contains at least one of calcium silicate and alumina silicate.

In a further embodiment of any of the foregoing gas heaters, the gas heater is configured to heat gas to a temperature of about 1652° F. (900° C.).

In a further embodiment of any of the foregoing gas heaters, the housing includes an inlet portion and an outlet portion. The inlet portion is connected to the outlet portion via at least one bolt arranged outside of the pressure vessel.

In a further embodiment of any of the foregoing gas heaters, includes fittings disposed within the inlet portion of the housing for communicating electrical power to the heating element.

In a further embodiment of any of the foregoing gas heaters, further including an inlet tube extending through the pressure vessel including apertures to facilitate diffusion.

In a further embodiment of any of the foregoing gas heaters, the layer of thermal insulation is in direct contact with the pressure vessel.

A cold spray material deposition system according to an exemplary embodiment of this disclosure, among other possible things includes a gas heater including a housing defining an inlet and an outlet for a gas stream. A pressure vessel defines a gas path through the housing. A heating element is supported within the pressure vessel and within the gas path for heating the gas stream. A layer of thermal insulation is disposed between the heating element an interior wall of the pressure vessel. A diffuser is arranged within the gas path between the inlet and the heating element for spreading the gas stream prior to entering the heating element. A cold spray device is configured to receive a heated gas stream from the gas heater, inject a material for deposition into the heated gas stream and propel the gas stream and material onto a substrate.

In a further embodiment of any of the foregoing cold spray material deposition systems, includes a power supply for supplying power to the heating element and a controller for controlling the power supply and operation of the heating element.

In a further embodiment of any of the foregoing cold spray material deposition systems, includes at least one thermocouple configured to provide information indicative of a temperature of the gas stream.

In a further embodiment of any of the foregoing cold spray material deposition systems, includes a temperature controller configured to control the temperature of the gas heater based on information from the at least one thermocouple.

In a further embodiment of any of the foregoing cold spray material deposition systems, includes a mass flow controller and a pressure regulator upstream from the gas heater.

In a further embodiment of any of the foregoing cold spray material deposition systems, the inlet includes an inlet tube including apertures to facilitate diffusion of incoming gas flow.

A method of operating a cold spray material deposition system according to an exemplary embodiment of this disclosure, among other possible things includes streaming a pressurized stream of gas from a pressure vessel, insulating a heating element from the pressure vessel, diffusing the gas stream with a diffuser disposed between an inlet and the heating element, and heating an incoming gas stream with the heating element to generate a gas stream output through the outlet that is of a desired temperature and pressure.

In a further embodiment of any of the foregoing methods, includes supplying the heated gas stream to a cold spray device configured to mix a material for deposition into the gas stream and propel the gas stream and material for deposition onto a substrate.

In a further embodiment of any of the foregoing methods, includes measuring a temperature of the gas stream at one of an inlet to the external housing and after an outlet from the external housing and adjusting power to the gas heater based on at least one measured temperature.

In a further embodiment of any of the foregoing methods, at least one of a gas input into the external housing and a heated gas stream output from the external housing are at a pressure of approximately 600 psi (4137.85 kPa).

In a further embodiment of any of the foregoing methods, includes insulating the heating element from the pressure vessel with a layer of thermal insulation between the heating element and an interior wall of the pressure vessel.

### BRIEF DESCRIPTION OF THE DRAWINGS

The disclosure can be further understood by reference to the following detailed description when considered in connection with the accompanying drawings wherein:

FIG. 1 schematically illustrates an example portable high temperature and high pressure gas heater.

FIG. 2 schematically illustrates the gas heater of FIG. 1 in operation.

### DETAILED DESCRIPTION

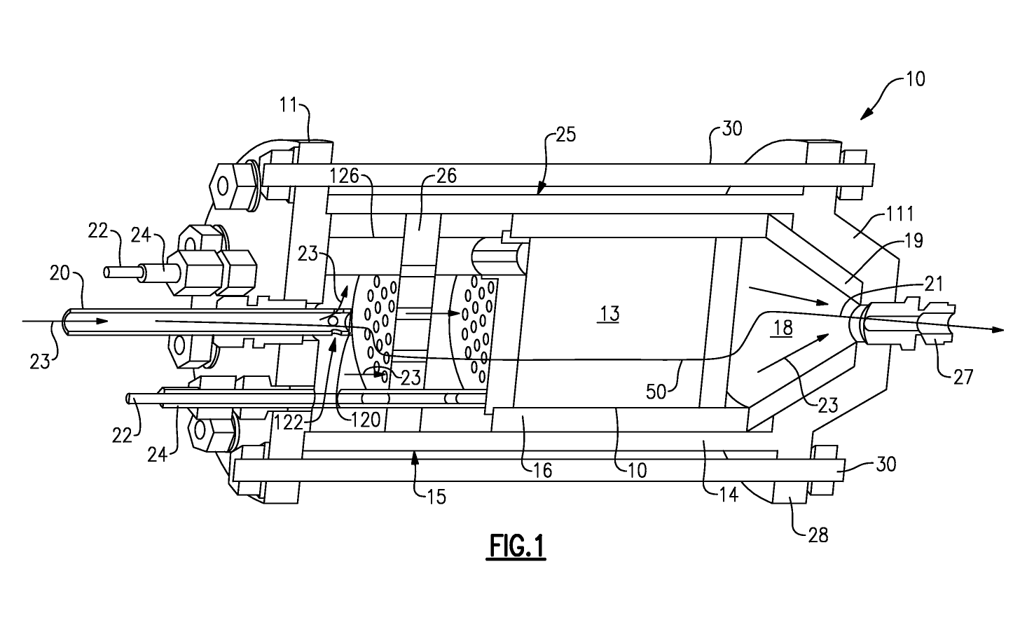

Referring to FIG. 1, an example gas heater 10 is schematically shown and includes an outer housing 25. The outer housing 25 defines an inlet portion 11 and an outlet portion 111 for a gas stream. The gas heater 10 is relatively small, allowing for portability. In one embodiment, the heater is approximately one foot (30.5 cm) in length, though other lengths and sizes may be used based on the requirements of the application as would be understood by those of ordinary skill in the art. In an embodiment, the gas heater 10 may be designed to run at a pressure of approximately 600 psi (4137.85 kPa) while heating the outlet gas to a temperature of approximately 1652° F. (900° C.). In one disclosed embodiment, the outlet gas temperature may be 1470° F. (800° C.). In other embodiments the pressure or temperature may be greater or less based on the specific requirements of the application. In an embodiment, the gas heater 10 may be used for cold spray material deposition. In another embodiment, the heater 10 may be used for other applications requiring heating of a flowing fluid stream.

The gas heater 10 includes a heating element 13. In an embodiment, the heating element 13 is ceramic and includes a spiral resistive heating element. The heating element 13 may be removable from the outer housing 25 to facilitate replacement after a desired time of use. The heating element 13 is configured to run on standard voltage supplies. In one embodiment the gas heater 10 is configured to operate utilizing a standard 480V three-phase power supply. The use of standard power supply increases portability and reduces overall gas heater weight.

The heating element 13 is supported in a pressure vessel 14. A layer of thermal insulation 16 is disposed between the heating element 13 and an interior wall of the pressure vessel 14. In one embodiment, the insulation 16 is in direct contact with the pressure vessel 14. The thermal insulation 16 is a high-performance, high-strength insulation. The thermal insulation 16 may be a ceramic material or fiber-reinforced ceramic material such as calcium silicate, alumina silicate, or a combination of the two. In another embodiment the thermal insulation 16 may include one or more types of insulating materials. An embodiment of the thermal insulation 16 includes a density between 3 and 15 lb/ft³ (48.1-240.3 kg/m³). In an embodiment, the thermal insulation 16 includes a relatively low heat conductivity of between 0.8 and 1.05. The combination of the thermal insulation density and low heat conductivity provide for operation of the heating element 13 at higher temperatures without generating external temperatures on the exterior surface 15 of the gas heater 10 that require special handling. Accordingly, the disclosed insulation characteristics provide for operation of the heating element 13 such that the gas stream 23 may be heated to higher temperatures and operated at higher pressures while maintaining the exterior surface 15 at temperatures within desired temperature limits, such as around room temperature.

A gas flow path 50 is defined through the housing 25 by the pressure vessel 14. The heating element 13 is disposed in the gas flow path 50. A portion 21 of the gas path 50 is defined through the space 18 defined by nozzle portion 19 located downstream of the heating element 13. The nozzle portion 19 communicates gas flow stream schematically indicated by arrows 23 to the outlet 27. An inlet tube 20 receives gas stream 23 and extends through the inlet portion 11 and the pressure vessel 14 on a side opposite the outlet 27.

In operation, cold air, for example, air at or below room temperature is fed into the heater 10 through the inlet tube 20.

The thermal insulation 16 provides for operation and at high pressures without concerns for the detrimental effect of temperature on the pressure capability of the pressure vessel 14. The relatively cool temperatures provided on the inlet side of the housing provides for the use of pass-through electrical wiring for the heating element 13 communicated through electrically insulated fittings 22 disposed in the inlet 11 portion. The fittings 22 may be copper fittings surrounded by an electrically insulating ceramic layer 24, in one embodiment.

In an embodiment, the inlet tube 20 is capped and cross-drilled to form apertures which facilitate gas diffusion into the heating element 13. An end 120 of the inlet tube 20 includes apertures 122 which facilitate gas diffusion. In an embodiment, an additional diffuser 26 may also be arranged within the gas flow path 50 between the inlet tube 20 and the heating element 13 to spread the gas stream prior to it entering the heating element 13. In the illustrated example, the additional diffuser 26 includes apertures 126 through which gas flows. The outlet 27 is located downstream of the heating element 13.

The outlet portion 111 of the outer housing includes a flange 28. Bolts 30 connect the inlet portion 11 of the outer housing 25 to the flange 28 of the outlet portion 111. In an embodiment, the bolts 30 may be installed outside of the pressure vessel 14 to reduce the effect of temperatures such as the potential of the bolts 30 to seize up due to extreme heat.

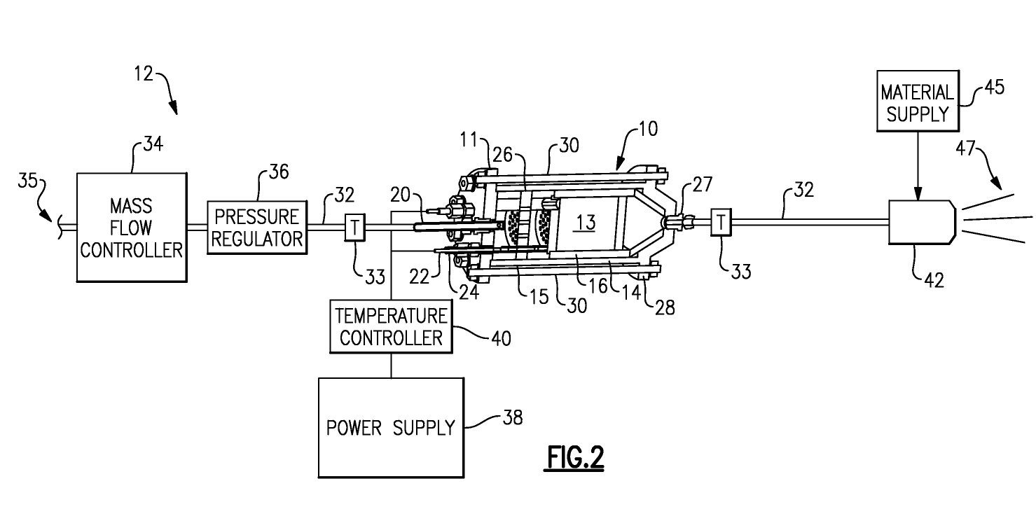

Referring to FIG. 2 with continued reference to FIG. 1, the heater 10 is shown schematically as part of a cold spray system 12. Conduits 32 are connected to the inlet tube 20 and the outlet 27 of the heater 10. In this example the conduits are tubing that could be flexible or rigid depending on application requirements. The conduits 32 are configured to withstand the pressure and temperatures encountered during operation of the cold spray system 12. In an embodiment, thermocouples 33 are arranged at both the inlet tube 20 to the outer housing 25 and the outlet 27 from the outer housing 25 to generate signals indicative of inlet and outlet temperature of gas flow. It should be understood that the other temperature sensing methods and devices could also be utilized, and/or a thermocouple could be utilized at only one of the inlet tube 20 and the outlet 27. Monitoring of inlet and outlet temperatures provides information that can be utilized for adjusting operation of the heater 10. A temperature controller 40 receives information indicative of the temperature of the gas stream traveling through the heater 10 from the thermocouples 33 and uses that information to control power supplied to and operation of the heating element 13, and thereby the temperature of outgoing gas flow.

In this example, a mass flow controller 34 is located downstream of a gas inlet 35 and upstream from the gas heater 10 for controlling the intake of gas into the heater 10. The mass flow controller 34 may be automated to continually adjust inflow to provide a desired mass flow. The mass flow controller 34 may also be manually operated and include a readout to provide for manual adjustment of incoming gas flow. A pressure regulator 36 is included upstream from the inlet tube 20 after the mass flow controller 34 to monitor and control inlet gas pressure. A power supply 38 supplies power to the heating element 13 through electrical wires that extend through the fittings 22 in the inlet portion 11 of the outer housing 25.

The outlet 27 is connected to a cold spray device 42 by the conduit 32. The cold spray device 42 may include a hand held spray gun or a nozzle mounted to a machine for movement relative to a substrate. The cold spray device 42 receives powdered material from a power material supply 45, mixes the powdered material with the gas flow and propels the material as indicated at 47 onto a substrate. The material is propelled by the gas stream 23 generated through the heater 10.

In operation, air or other gases at room temperature are drawn in through the inlet 35. The inlet 35 may be attached to a pressurized supply of air or other gas. The pressurized gas is communicated to the inlet tube 20 and into the heater 10. Gas within the heater 10 is communicated through the diffuser end 120 of the inlet tube 20 within the pressure vessel 14. The gas stream 23 is drawn through an additional diffuser 26 to the heating element 13. The heating element heats the gas stream 23 that causes a relative expansion of gases. The gas stream 23 is then compressed through the nozzle portion 19 to increase speed through the outlet 27. The now high speed, high temperature gas stream 23 is communicated to the cold spray device 42. In the cold spray device, powdered material is injected into the high speed gas stream and propelled out of the cold spray device 42 as is schematically shown at 47. The propelled material is applied to a substrate and is deposited from the resulting high speed impact.

The speed and temperature of the gas stream 23 is controlled by controlling the inlet pressures through a combination of the mass flow controller 34 and the pressure regulator 36. Moreover, control of the heating element 13 further provides control over the pressure and temperature of the gas stream communicated to the cold spray device 42.

Accordingly, the example heater 10 enables increased pressures and temperatures to improve cold spray deposition capabilities and performance, while maintaining exterior elements within a desired temperature range.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gas heater for a cold spray deposition system comprising:
a housing defining an inlet and an outlet for a gas stream;
a pressure vessel defining a gas path through the housing;
a heating element supported within the pressure vessel and within the gas path for heating the gas stream;
a layer of thermal insulation disposed between the heating element and an interior wall of the pressure vessel; and
a diffuser arranged within the gas path between the inlet and the heating element for spreading the gas stream prior to entering the heating element.

2. The gas heater of claim 1, wherein the layer of thermal insulation contains at least one of calcium silicate and alumina silicate.

3. The gas heater of claim 1, wherein the gas heater is configured to heat gas to a temperature of about 1652° F. (900° C.).

4. The gas heater of claim 1, wherein the housing includes an inlet portion and an outlet portion, wherein the inlet portion is connected to the outlet portion via at least one bolt arranged outside of the pressure vessel.

5. The gas heater of claim 4, including fittings disposed within the inlet portion of the housing for communicating electrical power to the heating element.

6. The gas heater of claim 1, further comprising an inlet tube extending through the pressure vessel including apertures to facilitate diffusion.

7. The gas heater of claim 1, wherein the layer of thermal insulation is in direct contact with the pressure vessel.

8. A cold spray material deposition system comprising:
a gas heater including a housing defining an inlet and an outlet for a gas stream, a pressure vessel defining a gas path through the housing, a heating element supported within the pressure vessel and within the gas path for heating the gas stream, a layer of thermal insulation disposed between the heating element an interior wall of the pressure vessel, and a diffuser arranged within the gas path between the inlet and the heating element for spreading the gas stream prior to entering the heating element; and
a cold spray device configured to receive a heated gas stream from the gas heater, inject a material for deposition into the heated gas stream and propel the gas stream and material onto a substrate.

9. The cold spray material deposition system as recited in claim 8, including a power supply for supplying power to the heating element and a controller for controlling the power supply and operation of the heating element.

10. The cold spray material deposition system as recited in claim 9, including at least one thermocouple configured to provide information indicative of a temperature of the gas stream.

11. The cold spray material deposition system as recited in claim 10, including a temperature controller configured to control the temperature of the gas heater based on information from the at least one thermocouple.

12. The cold spray material deposition system as recited in claim 10, including a mass flow controller and a pressure regulator upstream from the gas heater.

13. The cold spray material deposition system as recited in claim 10, wherein the inlet includes an inlet tube including apertures to facilitate diffusion of incoming gas flow.

14. A method of operating a cold spray material deposition system comprising:
streaming a pressurized stream of gas from a pressure vessel;
insulating a heating element from the pressure vessel;
diffusing the gas stream with a diffuser disposed between an inlet and the heating element; and
heating an incoming gas stream with the heating element to generate a gas stream output through the outlet that is of a desired temperature and pressure.

15. The method as recited in claim 14, including supplying the heated gas stream to a cold spray device configured to mix a material for deposition into the gas stream and propel the gas stream and material for deposition onto a substrate.

16. The method as recited in claim 15, including measuring a temperature of the gas stream at one of an inlet to the external housing and after an outlet from the external housing and adjusting power to the gas heater based on at least one measured temperature.

17. The method as recited in claim 14, wherein at least one of a gas input into the external housing and a heated gas stream output from the external housing are at a pressure of approximately 600 psi (4137.85 kPa).

18. The method as recited in claim 14, including insulating the heating element from the pressure vessel with a layer of thermal insulation between the heating element and an interior wall of the pressure vessel.
